(19) United States
(12) Patent Application Publication
(10) Pub. No.: US 2010/0143101 A1
(43) Pub. Date: Jun. 10, 2010

(54) COMPLIANT FOIL SEAL FOR ROTARY MACHINES

(75) Inventors: Biao Fang, Clifton Park, NY (US); Christopher Edward Wolfe, Niskayuna, NY (US); Edip Sevincer, Schenectady, NY (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/329,224

(22) Filed: Dec. 5, 2008

(51) Int. Cl. F01D 11/08; F16J 15/16

(52) U.S. Cl. 415/173.1; 277/406

(57) ABSTRACT

A compliant foil seal comprises a bottom foil configured to be located circumferentially around at least a portion of a rotor, and one or more upper foils configured to cooperate with a stator to position the bottom foil to compliantly face the rotor and be located between the stator and the rotor. A compliant foil seal assembly and a rotary machine are also presented.

### BACKGROUND

This invention relates generally to seals for rotary machines. More particularly, this invention relates to compliant foil seals for minimizing leakage of fluids flowing through the rotary machines.

Various types of rotary machines, such as gas turbine engines are known and widely used. Efficiency of the rotary machines depends upon internal tolerances of components of the rotary machines. For example, a loose tolerance rotary machine may have a relatively poor fit between internal components and may therefore exhibit poor efficiency, such as relatively high leakage of fluids occurring within the rotary machine from regions with high pressure to regions with lower pressure.

In order to minimize the leakage of the fluids occurring within the rotary machines to desired levels, different types of clearance seals are employed in the rotary machines. However, varying operation conditions of the rotary machines present some difficulties when designing these clearance seals. For example, when rotating shafts of the rotary machines rotate, they may undergo slight centrifugal growths at high rotational speeds. In addition, during rotation, these shafts may undergo radial excursions caused by extreme speed changes, temperature fluctuations, non-concentric alignment, or other factors. Thus, the clearance seals should be adapted to these dynamic conditions.

Labyrinth seals are clearance seals, which break down pressure by using a series of teeth or blades in close proximity to rotating shafts. Such seals are known and reliable. However, the labyrinth seals may allow high rates of gas leakage and are typically intolerant of excursions of the rotating shaft.

Therefore, there is a need for a new and improved compliant foil seal for minimizing leakage of fluids flowing through rotary machines.

### BRIEF DESCRIPTION

A compliant foil seal is provided in accordance with one embodiment of the invention. The compliant foil seal comprises a bottom foil configured to be located circumferentially around a rotor, and one or more upper foils configured to cooperate with a stator to position the bottom foil to compliantly face the rotor and be located between the stator and the rotor.

A compliant foil seal assembly is provided in accordance with another embodiment of the invention. The compliant foil seal comprises a plurality of compliant foil seals disposed end-to-end and configured to be located annularly around a rotor. Each compliant foil seal comprises a bottom foil configured to be located circumferentially around at least a portion of the rotor, and one or more upper foils configured to cooperate with a stator to position the bottom foil to compliantly face the rotor and locate between the stator and the rotor.

An embodiment of the invention further provides a rotary machine. The rotary machine comprises a stator, a rotor rotatably received in the stator, and a plurality of compliant foil seals disposed end to end to locate annularly around the rotor. Each compliant foil seal comprises a bottom foil configured to be locate circumferentially around at least a portion of the rotor, and one or more upper foils configured to cooperate with the stator to position the bottom foil to compliantly face the rotor and be located between the stator and the rotor.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a schematic diagram of a compliant foil seal in accordance with one embodiment of the invention;

FIG. 2 is a cross-sectional schematic diagram of a rotary machine useful in showing an assembly of the compliant foil seal, a stator, and a rotor thereof in accordance with one embodiment of the invention;

FIG. 3 is a schematic diagram of a compliant foil seal in accordance with another embodiment of the invention;

FIG. 4 is a schematic diagram of a rotary machine in accordance with another embodiment of the invention; and

FIG. 5 is an enlarged schematic diagram of a portion A of the rotary machine shown in FIG. 4.

### DETAILED DESCRIPTION OF THE DISCLOSURE

Preferred embodiments of the present disclosure will be described hereinbelow with reference to the accompanying drawings. In the following description, well-known functions or constructions are not described in detail to avoid obscuring the disclosure in unnecessary detail.

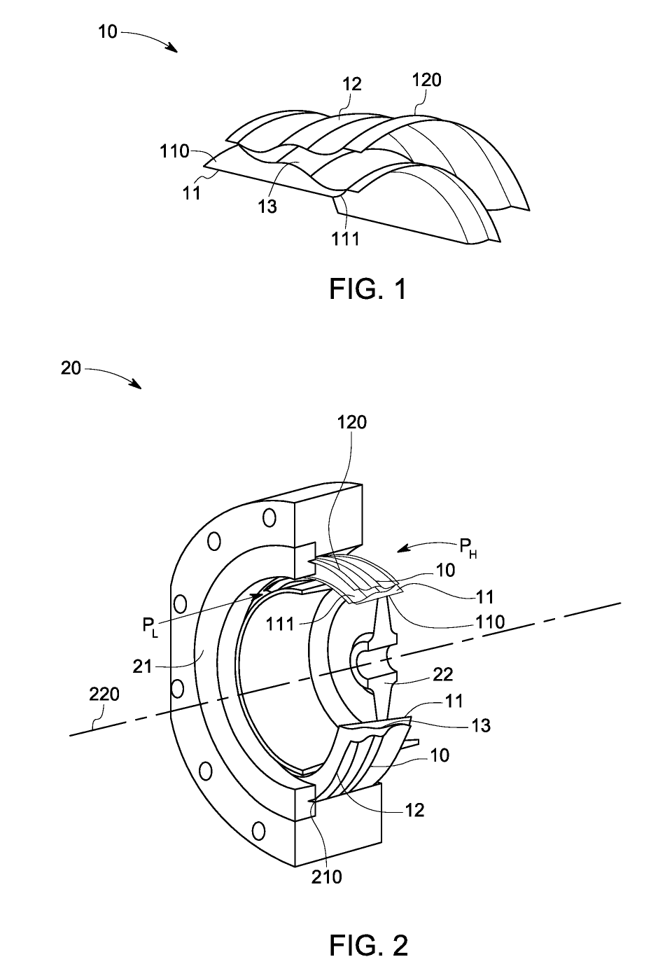

FIG. 1 illustrates a compliant foil seal 10 in accordance with one embodiment of the invention. In embodiments of the invention, the term “compliant” indicates the foil seal 10 may move in conformity with excursions or radial growth or the like of a rotor during its rotation to maintain a desired clearance therebetween. As illustrated in FIG. 1, the compliant foil seal 10 comprises a bottom foil 11, a first upper foil 12, and a second upper foil 13 connected to the bottom foil 11 and the first upper foil 12.

In embodiments of the invention, the bottom foil 11, the first upper foil 12, and the second upper foil 13 may be made from metals, such as nickel-based steels, beryllium-copper alloys, or beryllium-bronze alloys, which are fatigue-resistant and have strong mechanical strength. In some non-limiting examples, the bottom foil 11, the first upper foil 12, and the second upper foil 13 may be made from alloys, such as Ni-based metals, Rene™ superalloys (Rene is a trademark of General Electric Company) or Inconel™ superalloys (Inconel is a trademark of Special Metals Corporation) sheets, or other suitable alloys, which allow the foils 11-13 to be used at high temperatures. In one non-limiting example, the foils 11-13 are made from an alloy, sold under the trade name Inconel X-750, by Inco Alloys International, of Huntington, W. Va. Additionally, it should be understood that the material of the foils 11-13 may be varied depending on particular applications with which the compliant foil seal 10 is to be used.

In the illustrated embodiment, the bottom foil 11 is smooth and the first and second upper foils 12-13 are corrugated. The bottom foil 11 comprises a free end 110 and a connecting end 111 opposite to the free end 110. The connecting end 111 is bended upwardly to connect to one end (not labeled) of the second upper foil 13 so as to improve stiffness of the bottom foil 11. The second upper foil 13 further comprises another end (not labeled) opposite to the one end thereof connected to the bottom foil 11 to connect to an end of the first upper foil 12. The first upper foil 12 further comprises a flange end 120 opposite to the end thereof connected to the second upper foil 13. Thus, the compliant foil seal 10 is in Z-shape. Additionally, in one example, a width of the bottom foil 11 may be about 10 mm, and widths of the first and second upper foils 12-13 may be about 15 mm.

In embodiments of the invention, the bottom foil 11, the first upper foil 12, and the second upper foil 13 may be unitary. The term “unitary” indicate the foils 11-13 may be integrated together by some known methods, such as molding, welding and riveting, and may function as one element. That is, as illustrated in FIG. 1, the second upper foil 13 may be disposed on the bottom foil 11 and the first upper foil 11 by molding, welding, or riveting. Other suitable attachment methods for integrating the foils 11-13 may also be used. In some embodiments, the foils 11-13 may or may not be detached.

FIG. 2 illustrates a cross-sectional schematic diagram of a rotary machine 20. As illustrated in FIG. 2, the rotary machine 20 comprises a stator 21, a rotor 22 rotatably disposed in the stator 21, and a seal assembly (not labeled) comprising a plurality of compliant foil seals 10 disposed end-to-end (similar to a seal assembly 43 shown in FIG. 4) and circumferentially around at least a portion of the rotor 22.

It is should be noted that the embodiment of the rotary machine 20 in FIG. 2 is illustrative. In one non-limiting example, the seal assembly comprises five compliant foil seals 10 disposed end-to-end, and circumferentially or annularly around the entire rotor 22.

As illustrated in FIG. 2, the bottom foil 11 faces the rotor 22. The stator 21 comprises a recess 210 disposed circumferentially thereon. The flange end 120 of the first upper foil 12 is received in the recess 210 to hold the foils 11-13 between the stator 21 and the rotor 22. In some embodiments, the flange end 120 may be loosely or slidably received in the recess 210 directly so as to allow some flexibility of movement of the compliant foil seal 10 both radially and axially with respect to the rotor 22 so that the bottom foil 11 compliantly faces the rotor 22 to maintain a desired spacing therebetween to thereby perform a primary seal during rotation of the rotor 22. Alternatively, the flange end 120 may be fixed on the stator 21. In one non-limiting example, the flange end 120 is welded on the stator 21. In the illustrated embodiment, the first upper foil 12 may function as an elastic element, such as a spring to improve flexibility of the compliant foil seal 10, and the first and second upper foils 12-13 may perform a secondary seal to minimize the leakage during the rotation of the rotor 22. In one non-limiting example, the bottom foil 11 and/or the second upper foil 13 may not be held in the stator 21.

Additionally, in embodiments of the invention, the rotor 22 may rotate about an axis 220, thus, a radial direction may be defined as a direction toward or away from the axis 220, an axial direction may be defined as a direction along the axis 220 or parallel to the axis 220, and a circumferential direction may be defined as a direction extending around the axis 220.

In the illustrated embodiment, during operation, a region with a high pressure P_{H} and a region with a low pressure P_{L} are distributed at two sides of the compliant foil seal 10 so as to produce a pressure differential across the compliant foil seal 10. The free end 110 and the connecting end 111 of the bottom foil 11 are adjacent to the regions with the high and low pressures, respectively. With the rotation of the rotor 22 and the presence of the pressure differential, a fluid film such as a gas film is formed between the rotor 22 and the bottom foil 11 because of viscous hydrodynamic effects. A pressure of the gas film builds up gradually to lift the bottom foil 11 away from the rotor 22.

Thus, the formed gas film facilitates non-contact operation between the compliant foil seal 10 and the rotor 22, and supports the rotation of the rotor 22. The bottom foil 11 facilitates formation of the gas film so as to provide the primary seal to the rotator 22 between the high pressure and the low pressure regions. The first and second upper foils 12-13 facilitate the bottom foil 11 following excursions of the rotor 22, particularly when the rotor 22 has larger excursions. Additionally, the first and second upper foils 12-13 block paths through which the gas flows from the high-pressure region to the low-pressure region so as to function as the secondary seal. Accordingly, cooperation of the second upper foil 13, the bottom foil 11, and the fist upper foil 12 may minimize the leakage of the gas from the high-pressure region to the low-pressure region. In some examples, during operation, a small but tolerable amount of the gas may leak across the spacing (not labeled) between each bottom foil 11 and the rotor 22, and/or across gaps (not labeled) between every two adjacent compliant foil seals of the seal assembly.

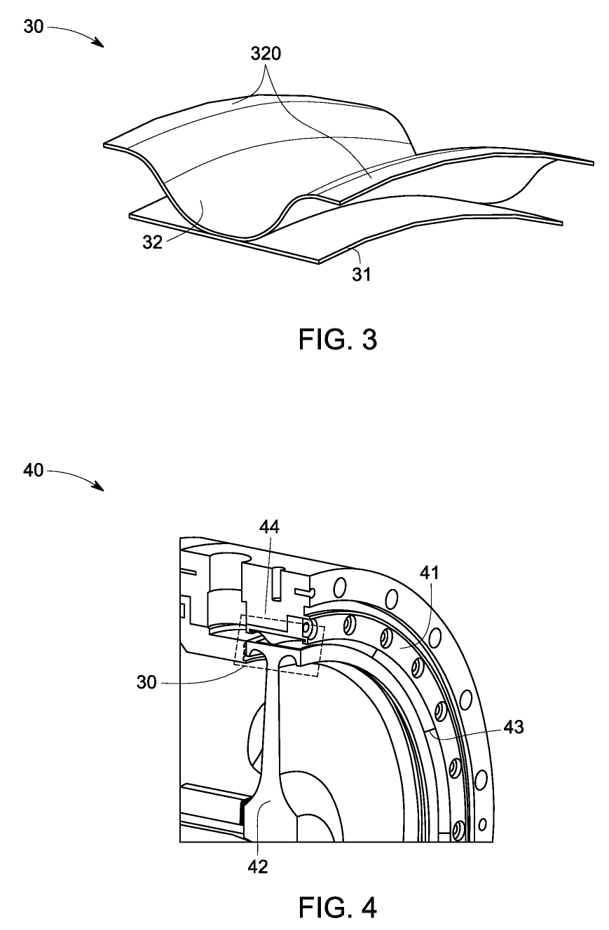

FIG. 3 illustrates a schematic diagram of a compliant foil seal 30 in accordance with another embodiment of the invention. As illustrated in FIG. 3, the compliant foil seal 30 comprises a bottom foil 31 and an upper foil 32. That is, in embodiments of the invention, the compliant foil seal may comprise the bottom foil and at least one upper foil. Additionally, material of the compliant foil seal 30 may be similar to the material of the compliant foil seal 10.

In the illustrated embodiment, the bottom foil 31 is smooth and has a width of about 10mm. The upper foil 32 is in a saddle shape and has a width of about 15mm. The upper foil 32 may be unitary with the bottom foil 31 and in one example is disposed on a middle portion of the bottom foil 31. Additionally, the upper foil 32, as shown, comprises two flange ends 320.

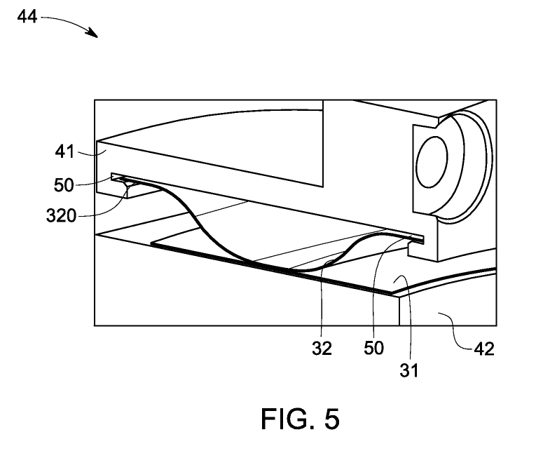

FIG. 4 illustrates a schematic diagram of a rotary machine 40 in accordance with another embodiment of the invention. FIG. 5 illustrates an enlarged schematic diagram of a portion 44 of the rotary machine 40 shown in FIG. 4. As illustrated in FIG. 4, the rotary machine 40 comprises a stator 41, a rotor 42 rotatably disposed in the stator 41, and the seal assembly 43 comprising a plurality of compliant foil seals 30 disposed end-to-end and circumferentially around at least a portion of the rotor 42.

Similar to the embodiment in FIG. 2, it is should be noted that the embodiment of the rotary machine 40 in FIG. 4 is illustrative. In one non-limiting example, the seal assembly 43 may comprise five compliant foil seals 30 disposed end-to-end, and circumferentially or annularly around the entire rotor 42. When the compliant foil seal 30 is assembled into the rotary machine 40, the bottom foil 31 is disposed circumferentially around the rotor 42. And two the flange ends 320 may be both loosely or slidably received in respective recesses 50 (shown in FIG. 5) in the stator 41 to hold the bottom foil 31 and the upper foil 32 between the stator 41 and the rotor 42 so as to allow some flexibility of movement of the compliant foil seal 30 both radially and axially with respect to the rotor 42. Alternatively, only one flange end 320 may be received in a respective recess (not shown) of the stator 21. In certain embodiments, the one or more flange ends 320 may be fixed on the stator 41. Accordingly, the bottom foil 31 compliantly faces the rotor 42 to maintain a desired spacing therebetween to thereby form a fluid film therebetween to facilitate a non-contact operation between the compliant foil seal 30 and the rotor 42 and to function as the primary seal during the rotation of the rotor 42. The upper foil 32 block paths through which the gas flows from the high-pressure region to the low-pressure region so as to function as the secondary seal. Additionally, the fluid film may support the rotation of the rotor 42.

In certain embodiments, the saddle-shaped upper foil 32 may not only function as an elastic element to improve flexibility of the compliant foil seal 30, but also block the paths through which the gas flows from the high-pressure region to the low-pressure region to perform the secondary seal. Additionally, a small but tolerable amount of the gas may leak across the spacing (not labeled) between each bottom foil 31 and the rotor 42, and/or across gaps (not labeled) between every two adjacent compliant foil seals 31 of the seal assembly.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the spirit and scope of the disclosure as defined by the following claims.

What is claimed is:

1. A compliant foil seal, comprising:
a bottom foil configured to be located circumferentially around at least a portion of a rotor; and
one or more upper foils configured to cooperate with a stator to position the bottom foil to compliantly face the rotor and be located between the stator and the rotor.

2. The compliant foil seal of claim 1, wherein the bottom foil and the one or more upper foils are unitary.

3. The compliant foil seal of claim 1, wherein at least one of the one or more upper foils is received in at least one recess defined in the stator.

4. The compliant foil seal of claim 1, wherein the compliant foil seal comprises one upper foil, and wherein the one upper foil comprises a saddle shape.

5. The compliant foil seal of claim 1, wherein the compliant foil seal comprises a first upper foil configured to cooperate with the stator directly and a second upper foil connected to the first upper foil and configured for holding the bottom foil.

6. The compliant foil seal of claim 5, wherein the compliant foil seal comprises a Z-shape.

7. The compliant foil seal of claim 5, wherein the first and second upper foils are corrugated.

8. The compliant foil seal of claim 1, wherein the bottom foil seal comprises a primary seal between high-pressure and low-pressure sides of the rotor during rotation of the rotor.

9. The compliant foil seal of claim 8, wherein the one or more upper foils is configured to further provide a secondary seal between the high-pressure and low-pressure sides of the rotor during the rotation of the rotor.

10. A compliant foil seal assembly, comprising:
a plurality of compliant foil seals disposed end-to-end and configured to be located annularly around a rotor, each compliant foil seal comprising:
a bottom foil configured to be located circumferentially around at least a portion of the rotor, and
one or more upper foils configured to cooperate with a stator to position the bottom foil to compliantly face the rotor and be located between the stator and the rotor.

11. The compliant foil seal assembly of claim 10, wherein the bottom foil and the one or more upper foils of each compliant foil sea are unitary.

12. The compliant foil seal of claim 10, wherein at least one of the one or more upper foils of each compliant foil sea is received in at least one recess defined in the stator.

13. The compliant foil seal of claim 10, wherein each compliant foil seal comprises one upper foil, and wherein the one upper foil comprises a saddle shape.

14. The compliant foil seal of claim 10, wherein each compliant foil seal comprises a first upper foil configured to cooperate with the stator directly and a second upper foil connected to the first upper foil and the bottom foil.

15. The compliant foil seal of claim 14, wherein each compliant foil seal comprises Z-shape.

16. The compliant foil seal of claim 14, wherein the first and second upper foils of each compliant foil sea are corrugated.

17. A rotary machine, comprising:
a stator;
a rotor rotatably received in the stator; and
a plurality of compliant foil seals disposed end-to-end to be located annularly around the rotor, wherein each compliant foil seal comprises:
a bottom foil configured to be located circumferentially around at least a portion of the rotor, and
one or more upper foils configured to cooperate with the stator to position the bottom foil to compliantly face the rotor and be located between the stator and the rotor.

18. The rotary machine of claim 17, wherein the stator comprises one or more recesses circumferentially distributed therein, and wherein at least one of the one or more upper foils is received in the respective one or more recesses.

19. The rotary machine of claim 18, wherein the bottom foil seal comprises a primary seal between high-pressure and low-pressure sides of the rotor during rotation of the rotor.

20. The rotary machine of claim 19, wherein the one or more upper foils of each compliant foil seal is configured to further provide a secondary seal between the high-pressure and low-pressure sides of the rotor during the rotation of the rotor.

21. The rotary machine of claim 17, wherein the bottom foil and the one or more upper foils of each compliant foil sea are unitary.

22. The rotary machine of claim 17, wherein each compliant foil seal comprises one upper foil, and wherein the one upper foil comprises a saddle shape.

23. The rotary machine of claim 17, wherein each compliant foil seal comprises a first upper foil configured to cooperate with the stator directly and a second upper foil connected to the first upper foil and the bottom foil.

24. The rotary machine of claim 23, wherein each compliant foil seal comprises Z-shape.
